(19) United States
(12) Patent Application Publication
(10) Pub. No.: US 2025/0112258 A1
(43) Pub. Date: Apr. 3, 2025

(54) FUEL CELL STACK

(71) Applicant: POWERCELL SWEDEN AB, Göteborg (SE)

(72) Inventor: Bengt STENEBY, Partille (SE)

(21) Appl. No.: 18/833,816

(22) PCT Filed: Feb. 6, 2023
(86) PCT No.: PCT/SE2023/050092

§ 371 Date: Jul. 26, 2024

(30) Foreign Application Priority Data
Feb. 11, 2022 (SE) 2250134-0

(51) Int. Cl. H01M 8/2483; H01M 8/0258; H01M 8/2484

(52) U.S. Cl. CPC H01M 8/2483; H01M 8/0258; H01M 8/2484

(57) ABSTRACT

A fuel cell stack is provided, which comprises at least a plurality of unit fuel cells, wherein each unit fuel cell comprises a bipolar plate and a membrane electrode assembly, which are stacked such that two bipolar plates sandwich a multi-layer membrane electrode assembly in a stacking direction. Each bipolar plate and/or membrane electrode assembly comprises at least one reactant inlet manifold and at least one reactant outlet manifold, wherein the manifolds form respective tubelike channel inlets and channel outlets. The channel inlets and channel outlets extend through the fuel cell stack for providing a reactant stream to and from the fuel cell stack, wherein the plurality of unit fuel cells is sandwiched by a cover plate and a feeding plate. The cover plate is configured to cover the fuel cell stack, wherein at least one turbulence element is arranged in the stream of reactant.

The present invention relates to a fuel cell stack.

Usually, a fuel cell stack comprises a plurality of membrane electrode assemblies (MEAs), which are separated by so called bipolar plates (BPP). The bipolar plates themselves usually comprise at least two electrically conducting metal plates, so called flow field plates, which are placed on top of each other and have a flow field for the reactants at one side and a flow field for a cooling fluid on the other side. Thereby, the cooling fluid flow fields are facing each other, wherein the reactant fluid flow fields face the MEAs. The electric current produced by the MEAs during operation of the fuel cell stack results in a voltage potential difference between the bipolar plate assemblies. Consequently, the individual bipolar plates must be kept electrically separated from each other under all circumstances in order to avoid a short circuit.

In an ideal case, all cells in the fuel cell stack should deliver an equal electrical voltage. However, it has been determined that there are some variations in the outputted electrical voltage for the different cells. The greatest deviations concern usually the first and last cells in the stacking direction. One reason for this is that the outermost cells, which is the first and last cells in the stacking direction, may have deviating conditions for a reactant flow which result in that the first cells in the flow direction usually receives less reactant than the intermediate cells, while the last cells in the flow direction usually receives more reactant than the intermediate cells.

This can be overcome by providing inactive bipolar plates at the beginning and at the end of the fuel cell stack. However, this has the drawback that a height of the fuel cell stack as such is increased without increasing the number of active unit fuel cells, whereas the voltage output is decreased. Also, the additional inactive bipolar plates increase an amount of work necessary for mounting the fuel cell stack.

It is therefore object of the present invention to provide a fuel cell stack having a more uniform energy output over the entire stack.

This object is solved by a fuel cell stack according to claim 1.

In the following, a fuel cell stack is provided, wherein the fuel cell stack comprises at least a plurality of unit fuel cells, wherein each unit fuel cell comprises a bipolar plate and a membrane electrode assembly, which are stacked such that two bipolar plates sandwich a multi-layer membrane electrode assembly in a stacking direction. Each bipolar plate and/or membrane electrode assembly comprises at least one reactant inlet manifold and at least one reactant outlet manifold, wherein the manifolds form respective tubelike channel inlets and channel outlets, wherein the channel inlets and channel outlets extend through the stack for providing a reactant stream to and from the stack. Furthermore, the plurality of unit fuel cells is sandwiched by a cover plate and a feeding plate, wherein the feeding plate comprises a reactant supply channel configured to connect the at least one reactant inlet manifold to a reactant supply and a reactant outlet channel configured to connect the at least one reactant outlet manifold to a reactant reservoir. The cover plate is configured to cover the fuel cell stack and usually has no reactant channels. More particularly, the cover plate may be configured to fluidly terminate the least one reactant inlet manifold and the at least one reactant outlet manifold.

In order to achieve a more uniform energy output over the entire fuel cell stack at least one turbulence element is arranged in the stream of reactant, wherein the turbulence element is configured to create at least one turbulence in a flow of the supplied fluid. The at least one turbulence element is arranged at the feeding plate in an area of the feeding plate, where the reactant streams in stacking direction, and/or the at least one turbulence element is arranged at the cover plate in an area of the cover plate, which is perpendicular to the stacking direction, and where the reactant streams perpendicular to the stacking direction.

Preferably, the at last one turbulence element is formed as a protrusion or a recess. Both shapes allow to increase the turbulences in the reactant flow.

According to a preferred embodiment, the turbulence element has an upstream side and a downstream side, wherein a shape of the turbulence element at the upstream side differs from a shape of the turbulence element at the downstream side. This allows to increase the turbulence of the reactant flow. Preferably, an inclination of the turbulence element at the downstream side is steeper than the inclination at the upstream side of the turbulence element. This shape may improve the turbulence in the streaming reactant flow which may also increase the energy output of the first and/or last cell. More particularly, the at least one turbulence element may be inclined with respect to the direction of the reactant flow and/or with respect to a surface normal of an inner wall of the feeding plate, where the at least one turbulence element is arranged.

Preferably, the fuel cell stack comprises at least one second turbulence element, wherein the at least one first turbulence element and the at least one turbulence second element are arranged next to one another. Additionally, the first and second turbulence element may be inclined with respect to each other. This may further improve the uniform energy output of the fuel cell stack by increasing the turbulence of the reactant flow.

According to a further preferred embodiment, the first and second turbulence element have the same shape or differ in shape. For example, the first turbulence element may be formed as a recess and the second turbulence element may be formed as a protrusion. This has the advantage that the generated turbulence in the reactant stream can be adapted.

Preferably, the fuel cell stack is provided with a plurality of turbulence elements, wherein the plurality of turbulence elements is evenly distributed. This allows to further improve the uniform energy output over the entire fuel cell stack. Preferably, the plurality of turbulence elements forms a structure on an inner wall of the reactant supply channel. Advantageously, all turbulence elements of the plurality of turbulence elements may have the same shape. Alternatively, the turbulence elements or a subgroup of the turbulence elements may differ in shape. For example, a portion of the turbulence elements of the plurality of turbulence elements may be formed as protrusions while the remaining portion may be formed as recesses. Furthermore, all or some turbulence elements of the plurality of turbulence elements may differ in size. Advantageously, the plurality of turbulence elements is formed during a manufacturing process of the feeding plate.

According to a further preferred embodiment, the at least one reactant supply channel has a first portion having a first dimension in at least one direction perpendicular to the flow direction of the reactant, and the at least one reactant supply channel has a second portion having a second dimension in at least one direction perpendicular to the flow direction, wherein the first dimension is smaller than the second dimension. Preferably, the dimensions of the second portion are chosen such that the second portion of the reactant supply channel is flush with the reactant inlet manifold and/or a shape of the first portion is adapted to a reactant supply channel. More particularly, the shape/diameter of the first portion may be circular, whereas the second portion may have any shape. For example, a difference between the shape and/or diameter of the first and second portion may lead to velocity differences within the reactant flow. Depending on the extent and/or distribution of these velocity differences variety of effects such as backflow, separations, and/or bubbles within the reactant flow can be enhanced or mitigated. By reducing the velocity differences in the reactant flow, the reactant flow itself may become more laminar and/or may have less or even no bubbles, which then can lead to a more uniform energy output of the unit fuel cells. Thus, due to the different dimension between the first and second portion of the reactant supply channel, a turbulence in the reactant flow can be further adapted such that a uniform energy output of the unit fuel cells in the fuel cell stack can be further improved.

Further preferred embodiments are defined in the dependent claims as well as in the description and the figures. Thereby, elements described or shown in combination with other elements may be present alone or in combination with other elements without departing from the scope of protection.

In the following, preferred embodiments of the invention are described in relation to the drawings, wherein the drawings are exemplarily only, and are not intended to limit the scope of protection. The scope of protection is defined by the accompanied claims, only.

The figures show:

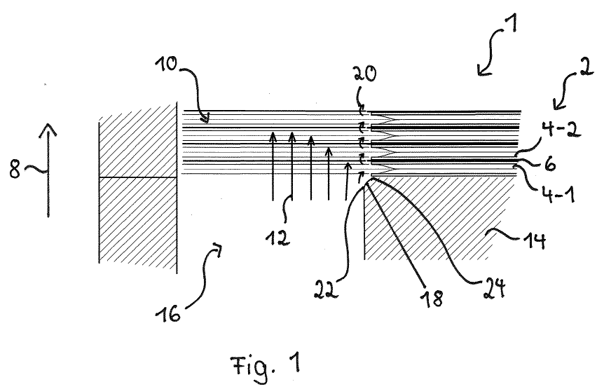

FIG. 1: a partial cross section through a fuel cell stack according to a first embodiment,

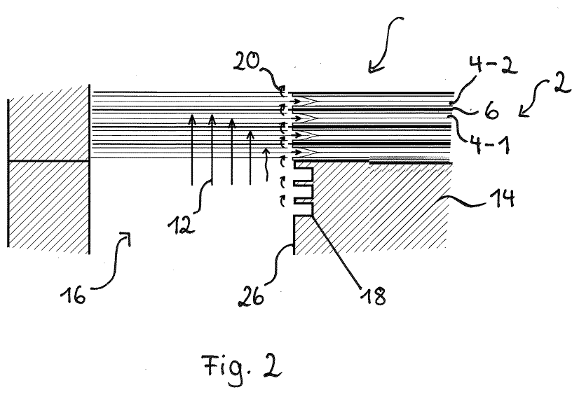

FIG. 2: a partial cross section through a fuel cell stack according to a second embodiment,

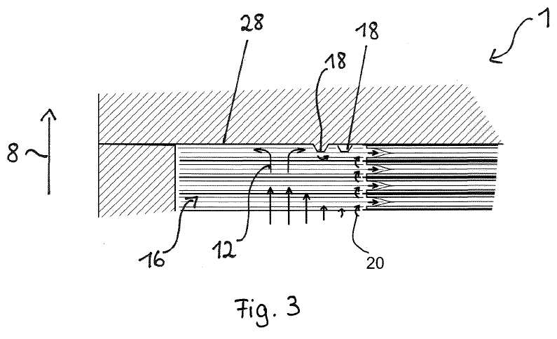

FIG. 3: a partial cross section through a fuel cell stack k according to a third embodiment,

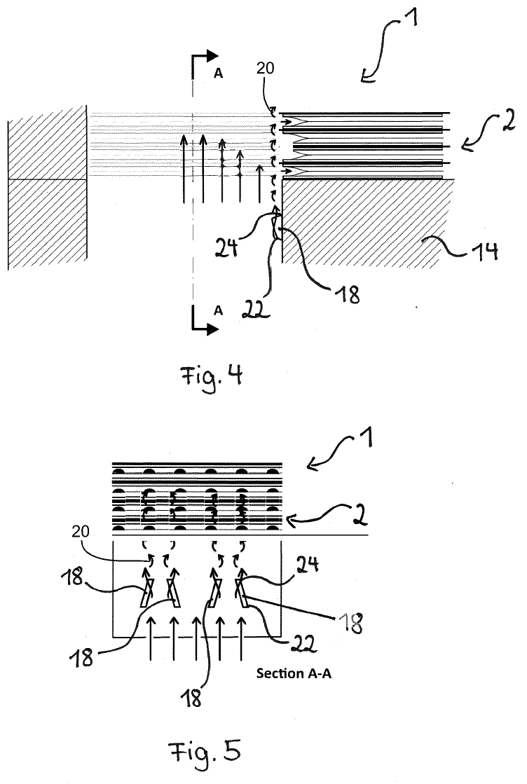

FIG. 4: a partial cross section through a fuel cell stack k according to a fourth embodiment,

FIG. 5: a section along the line A-A in FIG. 4.

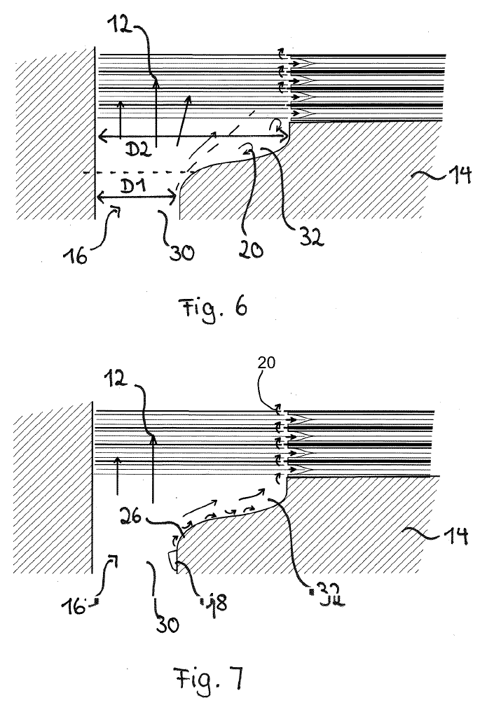

FIG. 6: a partial cross section through a fuel cell stack k according to a fifth embodiment, and

FIG. 7: a partial cross section through a fuel cell stack k according to a sixth embodiment.

In the following same or similar functioning elements are indicated with the same reference numerals.

FIG. 1 shows a fuel cell stack 1 according to first embodiment. The fuel cell stack 1 comprises at least a plurality of unit fuel cells 2, wherein each unit fuel cell comprises a bipolar plate 4 and a membrane electrode assembly 6, which are stacked such that two bipolar plates 4-1, 4-2 sandwich a multi-layer membrane electrode assembly 6 in a stacking direction 8.

Each bipolar plate 4 and/or membrane electrode assembly 6 comprises at least one reactant inlet manifold and at least one reactant outlet manifold, wherein the manifolds form respective tubelike channel inlets 10 and channel outlets (not shown). The channel inlets 10 and channel outlets extend through the stack 1 for providing a reactant stream, indicated by arrows 12, to and from the stack 1. Furthermore, the plurality of unit fuel cells is sandwiched by a cover plate (FIG. 3) configured to cover the fuel cell stack 1 and a feeding plate 14, wherein the feeding plate 14 comprises a reactant supply channel 16 configured to connect the at least one reactant inlet manifold to a reactant supply and a reactant outlet channel (not shown) configured to connect the at least one reactant outlet manifold to a reactant reservoir (not shown).

In order to achieve a more uniform energy output over the entire fuel cell stack 1, a turbulence element 18 is arranged in the stream of reactant 12. The turbulence element 18 in FIG. 1 is formed as a recess which is configured to create at least one turbulence (indicated by curved arrows 20) in a flow of the supplied reactant fluid 12. The turbulence element 18 is arranged in an area of the feeding plate 14, where the reactant streams in stacking direction 8.

The turbulence element 18 has an upstream side 22 and a downstream side 24. As can be seen in FIG. 1, a shape of the turbulence element 18 at the upstream side 22 differs from a shape of the turbulence element 18 at the downstream side 24. This allows to increase the turbulence of the reactant flow.

FIG. 2 shows a fuel cell stack 1 according to a second embodiment. The fuel cell stack 1 differs from the fuel cell stack 1 of FIG. 1 in that the fuel cell stack 1 of FIG. 2 is provided with three turbulence elements 18, which are recessed from an inner wall 26 and arranged next to each other. Further, they have a rectangular shape. Furthermore, the turbulence elements 18 are evenly distributed and form a structure on the inner wall 26 of the reactant supply channel 16. It should be noted that the number of turbulence elements 18 are not limited to three. The fuel cell stack 1 may be provided with more than three turbulence elements 18.

In contrast to FIGS. 1 and 2, FIG. 3 shows a top part of a fuel cell stack 1 according to a third embodiment. The fuel cell stack 1 is covered with a cover plate 28 which is configured to fluidly terminate the least one reactant inlet manifold 16 and the at least one reactant outlet manifold (not shown). In FIG. 3, the fuel cell stack 1 is provided with a turbulence element 18 which is formed as a protrusion. The turbulence element 18 of FIG. 3 is arranged at an area of the cover plate 28 which is perpendicular to the stacking direction 8, wherein the reactant flow 12 streams perpendicular to the stacking direction 8.

FIG. 4 shows a cross section of a fuel cell stack 1 according to a fourth embodiment, and FIG. 5 shows a section along the line A-A in FIG. 4. The fuel cell stack 1 of FIG. 4 differs from the fuel cell stack in FIG. 1 in that the fuel cell stack is provided with four turbulence elements 18 that are formed as a protrusion. Each of the turbulence elements have an upstream side 22 and a downstream side 24, wherein an inclination of the turbulence element 18 at the downstream side 24 is steeper than the inclination at the upstream side 22 of the turbulence element 18. As can be seen more clearly in FIG. 5, the turbulence elements 18 are arranged in pairs that are inclined with respect to each other. In FIG. 5, the first and second turbulence element 18 of each pair of turbulence elements 18 have the same shape. Alternatively, the turbulence elements may also differ in shape.

FIG. 6 shows a fuel cell stack 1 according to a fifth embodiment. The fuel cell stack 1 of FIG. 6 differs from the fuel cell stack 1 of FIG. 1 in that the reactant supply channel 16 has a first portion 30 having a first dimension D1 in at least one direction perpendicular to the flow direction 12 of the reactant, and a second portion 32 having a second dimension D2, wherein the first dimension D1 is smaller than the second dimension D2. Due to the different dimension between the first and second portion 30, 32 of the reactant supply channel 16, a turbulence as indicated with the curved arrow 20 can be generated in the reactant flow 12.

FIG. 7 shows a fuel cell stack 1 according to a sixth embodiment. The fuel cell stack 1 of FIG. 7 differs from the fuel cell stack 1 of FIG. 6 in that the fuel cell stack 1 is additionally provided with a turbulence element 18 which is arranged at an inner wall 26 of the first portion 30 of the reactant supply channel 16. In FIG. 7, the turbulence element 18 is formed as a protrusion. However, it is also possible to form the turbulence element 18 as a recess as shown in FIG. 2. The turbulence element 18 of FIG. 7 has the advantage that velocity differences in the reactant flow that could occur due to the differences in diameter between the first portion 30 and the second portion 32 can be mitigated. More particularly, the velocity differences in the reactant flow can lead to a variety of effects such as backflow, separations, and/or bubbles within the reactant flow. Because the turbulence element 18 reduces the velocity differences in the reactant flow, the reactant flow itself may become more laminar and/or may have less or even no bubbles.

In summary, by increasing the turbulence in the otherwise laminar flow of reactant in the reactant supply channel 16, a more uniform energy output over the entire fuel cell stack 1 can be achieved.

### REFERENCE NUMERALS

1 Fuel cell stack

2 unit fuel cell

4 bipolar plate

6 membrane electrode assembly

8 Stacking direction

10 channel inlet

12 reactant flow

14 feeding plate

16 reactant supply channel

18 turbulence element

20 turbulence

22 upstream side

24 downstream side

26 inner wall

28 cover plate

30 first portion

32 second portion

1. A fuel cell stack comprising at least
a plurality of unit fuel cells, wherein each unit fuel cell comprises a bi-polar plate and a membrane electrode assembly, which are stacked such that two bipolar plates sandwich a multi-layer membrane electrode assembly in a stacking direction, wherein each bipolar plate and/or membrane electrode assembly comprises at least one reactant inlet manifold and at least one reactant outlet manifold, wherein the manifolds form respective tubelike channel inlets and channel outlets, wherein the channel inlets and channel outlets extend through the fuel cell stack for providing a reactant stream to and from the fuel cell stack, wherein the plurality of unit fuel cells is sandwiched by a cover plate and a feeding plate, wherein the feeding plate comprises a reactant supply channel configured to connect the at least one reactant inlet manifold to a reactant supply and a reactant outlet channel con-figured to connect the at least one reactant outlet manifold to a reactant reservoir, wherein the cover plate is configured to cover the fuel cell stack,
wherein at least one turbulence element is arranged in the stream of reactant, wherein the turbulence element is configured to create at least one turbulence in a flow of the supplied fluid, wherein the at least one turbulence diverts the flow of the supplied fluid towards a first unit fuel cell and/or a last unit fuel cell in a stacking direction,
wherein the at least one turbulence element is arranged in an area of the feeding plate, where the reactant streams in stacking direction, and/or
wherein the at least one turbulence element is arranged at an area of the cover plate which is perpendicular to the stacking direction, where the reactant streams perpendicular to the stacking direction.

2. The fuel cell stack according to claim 1, wherein the at last one turbulence element is formed as a protrusion or a recess.

3. The fuel cell stack according to claim 1, wherein the at least one turbulence element has an upstream side and a downstream side, wherein a shape of the at least one turbulence element at the upstream side differs from a shape of the turbulence element at the downstream side.

4. The fuel cell stack according to claim 3, wherein an inclination of the turbulence element at the downstream side is steeper than the inclination at the upstream side of the turbulence element.

5. The fuel cell stack according to claim 1, wherein the fuel cell stack comprises at least one second turbulence element, wherein the at least one first turbulence element and the at least one second turbulence element are arranged next to one another.

6. The fuel cell stack according to claim 5, wherein the first and second turbulence element are inclined with respect to each other.

7. The fuel cell stack according to claim 5, wherein the first and second turbulence element have the same shape or differ in shape.

8. The fuel cell stack according to claim 1, wherein the fuel cell stack is provided with a plurality of turbulence elements, wherein the plurality of turbulence elements is evenly distributed.

9. The fuel cell stack according to claim 8, wherein the plurality of turbulence elements forms a structure on an inner wall of the reactant supply channel.

10. The fuel cell stack according to claim 1, wherein the at least one reactant supply channel has a first portion having a first dimension in at least one direction perpendicular to the flow direction of the reactant, and the at least one reactant supply channel has a second portion having a second dimension in at least one direction perpendicular to the flow direction, wherein the first dimension is smaller than the second dimension.
